(19) United States
(12) Patent Application Publication
(10) Pub. No.: US 2019/0141432 A1
(43) Pub. Date: May 9, 2019

(54) ASSEMBLY FOR A PERSONAL AUDIO DEVICE

(71) Applicant: Sonion Nederland B.V., Hoofddorp (NL)

(72) Inventors: Alwin Fransen, Hoofddorp (NL); Jelle Heuveling, Hoofddorp (NL); Dion Ivo de Roo, Hoofddorp (NL); Ewian Vos, Hoofddorp (NL); Theodorus Maria Verhaar, Hoofddorp (NL)

(21) Appl. No.: 16/184,524

(22) Filed: Nov. 8, 2018

(30) Foreign Application Priority Data
Nov. 9, 2017 (EP) 17200768.4

(51) Int. Cl. H04R 1/10; H04R 3/04

(52) U.S. Cl. CPC H04R 1/1058; H04R 2460/13; H04R 3/04

(57) ABSTRACT

An assembly for a personal audio device configured to amplify and process a signal and to output this signal as sound into an ear canal of a user. The assembly includes a housing portion and a transducer. The housing portion includes a cavity configured to receive the transducer via an opening in the housing portion. The transducer includes a fixing member configured for attachment of the transducer to the housing. The fixing member includes an edge portion extending from the transducer and is configured to support the transducer in the cavity. The edge portion forms a serrated surface for engagement between the transducer and an inner portion of the cavity.

This application claims the benefit of European Patent Application No. 17200768.4, filed Nov. 9, 2017, which is incorporated herein by reference in its entirety.

### FIELD OF THE INVENTION

The present invention relates to an assembly for a personal audio device. The assembly comprises a housing portion and a transducer, where the housing portion comprises a cavity configured to receive the transducer via an opening in the housing portion.

### BACKGROUND OF THE INVENTION

Traditionally relative large openings are required in the housing to insert the transducer in the housing. This results in large placement tolerances and may make sealing difficult, in particular in relation to miniature assemblies for use in hearing aids and other personal audio devices.

### DESCRIPTION OF THE INVENTION

It is an object of embodiments of the invention to provide an improved assembly for a personal audio device.

According to a first aspect, the invention provides an assembly for a personal audio device configured to amplify and process a signal and to output this signal as sound into an ear canal of a user, the assembly comprising a housing portion and a transducer, wherein the housing portion comprises a cavity configured to receive the transducer via an opening in the housing portion, and wherein the transducer comprises a fixing member configured for attachment of the transducer to the housing, wherein the fixing member comprises an edge portion extending from the transducer and being configured to support the transducer in the cavity, and the edge portion forms a serrated surface for engagement between the transducer and an inner portion of the cavity.

The housing portion of the present invention may be seen as at least part of a housing of a personal audio device, such as a hearing aid. Depending on the type of personal audio device the housing portion may be considered a faceplate. The housing portion of the present invention is intended for use in relation personal audio devices. The personal audio device may in principle be any type of hearing devices, such as behind-the-ear, in-the-ear, in-the-canal, invisible-in-canal and completely-in-canal devices.

In the context of the present invention, the term “hearing device” shall be understood as an electroacoustic device which is adapted to amplify and process a signal and to output this signal as sound to a user, such as into the ear canal of a user.

The transducer may convert both ways between electrical power and sound, thus being applicable both as a receiver, such as a loudspeaker in a hearing device, and as a microphone.

In one embodiment, the transducer is adapted to transform sound into an electrical signal, whereby sound waves may act on a membrane, and whereby movement of the membrane is electrostatically transferred to an electrical voltage.

In one embodiment, the transducer is adapted to transform electrical energy into mechanical energy by movement of an armature whereby sound waves may be created by movement of a membrane which may be coupled to the moving armature.

Thus, the transducer may be either an input device such as a microphone, or and output device such as a loudspeaker (receiver), or a bone conduction actuator.

Furthermore, the transducer may receive signals from external sources, such as a telecoil, an IR source, an RF source, light, vibrations/accelerations for e.g. voice pick-up or detection of movement/rotation of the device, etc. And the transducer may transmit signals to other external receivers by means of near field magnetic induction, RF, etc.

The housing portion comprises a cavity configured to receive at least a part of the transducer. The transducer is received in the cavity via an opening in the housing portion. To facilitate that the transducer is kept in place in the cavity, the transducer comprises a fixing member configured for attachment of the transducer to the housing. The fixing member comprises an edge portion extending from the transducer, which fixing member is configured to support the transducer in the cavity. The edge portion forms a serrated surface for engagement between the transducer and an inner portion of the cavity.

The serrated surface may ensure that the transducer is kept in place while permanently fixing it, e.g. by gluing or by other means fixing the transducer in the cavity. In an alternative embodiment, the serrated surface itself may ensure permanently fixing of the transducer.

It should be understood, that the fixing member in one embodiment may be a separate element attached to the transducer, whereas the fixing member in an alternative embodiment may form part of the transducer.

It should further be understood, that the fixing member may form a plurality of serrated surfaces. At least one of the serrated surface(s) may comprise a serrated edge, a plurality of serrated edges, an area comprising a serration.

In the context of the present invention, the term “serrated” edge/surface should be understood as an edge/a surface at with a plurality of teeth. The teeth may be uniformly distributed or alternatively non-uniformly distributed. The teeth may be of the same size or may be of different size. Furthermore, the shape of the teeth may be uniform or non-uniform. It should further be understood, that a depth between two adjacent teeth; i.e. the size of a trough, may vary along the serrated surface/edge.

The size of the serrated surface may be defined by the size of the teeth. The height of the teeth may be in the range of 0.05-0.5 mm, whereas the width of the teeth may be in the range of 0.1-2.0 mm. The height may be defined as the distance from the trough between two adjacent teeth to the top of the teeth, whereas the width of the teeth may be defined as the distance from one trough to the next trough. The length of the serrated surface may be in the range of 0.3-3.0 mm, where the length is defined as the distance from the first tooth to the last tooth in the longitudinal direction of the serrated surface.

In the context of the present invention, the term “engagement between the serrated surface and an inner portion of the cavity” should be understood as fixing of the transducer to the housing portion by insertion of at least a part of at least one of the teeth forming the serrated surface into a part of the housing. The part of the housing may be an outer surface of the inner portion of the cavity.

It should however be understood, that the term “engagement between the serrated surface and an inner portion of the cavity” in one embodiment should be understood as fixing of the transducer to the housing portion by frictional forces between at least one of the teeth forming the serrated surface and an outer surface of the inner portion of the cavity.

In one embodiment, at least a part of the cavity has a shape which matches at least a part of the transducer for engagement between the housing portion and the transducer by frictional forces. The cavity may match the transducer itself and/or an attachment part of the transducer and/or the serrated surface.

The fixing member comprises an edge portion extending from the transducer, which edge portion is configured to support the transducer in the cavity. The edge portion extending from the transducer may be an elongated element attached to or forming part of the fixing member. To facilitate insertion of the transducer into the opening in the housing part the edge portion may be arranged at a surface of the transducer which is substantially parallel to the insertion direction where by the transducer can be inserted along the length of the edge portion.

It should be understood, that the fixing member may comprise a plurality of edge portions, such as two, three, or even more edge portions. It should further be understood, that the serrated surface may form part of the edge portion or alternatively that the serrated surface may constitute the edge portion; i.e. a part of the edge portion may form a serrated surface or the entire edge portion may form a serrated surface.

To facilitate insertion of the transducer into the cavity via the opening, the cavity may comprise at least one elongated indentation formed in an inner surface. The indentation may extend from the opening and into the cavity and thereby being configured to guide the transducer during placement and removal of the transducer into and out of the cavity.

The edge portion may be configured for insertion into the elongated indentation. This may be achieved by providing the edge portion with a shape and size which matches the shape and size of the at least one indentation.

In one embodiment, the elongated indentation extends transverse to the serrated surface. Thus, guiding of the transducer into and out of the housing portion may be achieved in a first plane whereas fixing of the transducer in the housing portion by the serrated surface may be achieved in a second plane being transverse to the first plane.

To facilitate engagement between the housing portion and the fixing member, the housing portion may comprise an engagement portion for engagement with the serrated surface. The engagement portion may comprise a material and/or may be formed of a material being softer than serrated surface. A softer material may facilitate that at least a part of at least some of the teeth forming the serrated surface is pushed through the material.

The assembly may further comprise a sealing member arranged in the cavity to seal a gap between the transducer and the housing portion. This may be of particular relevance for embodiment, where the outer shape of the transducer does not match the inner shape of the cavity. The sealing member may as an example be formed of a flexible material thereby facilitating positioning of the sealing member. Alternatively, the sealing member may be formed by an adhesive which may be positioned before or after insertion of the transducer in the cavity.

The transducer may form a sound opening for receiving sound or for outputting sound dependent on whether the transducer is an input device such as a microphone, or and output device such as a loudspeaker (receiver). The fixing member may be attached to the transducer such that the sound opening is partly covered by the fixing member. Furthermore, the fixing member may be attached such that a gap between the fixing member and the transducer defines a spout member. The spout member may thus form a passage for sound from or to the transducer.

The assembly may further comprise an acoustic filter arranged at the transducer. Preferably, the acoustic filter is arranged at or in the sound opening such that sound may pass the acoustic filter between the transducer and the surroundings.

Alternatively or additionally, the assembly may further comprise a porous element arranged at the transducer for contamination protection of the transducer. Preferably, the acoustic filter is arranged at or in the sound opening to avoid ingress of cerumen, dust, etc. and thereby facilitate contamination protection.

Alternatively or additionally, the assembly may further comprise a polymer foil arranged in the cavity for contamination protection of the transducer.

According to a second aspect, the invention provides a personal audio device comprising an assembly according to the first aspect of the invention.

It should be understood, that a skilled person would readily recognise that any feature described in combination with the first aspect of the invention could also be combined with the second aspect of the invention, and vice versa.

The assembly according to the first aspect of the invention is very suitable for the personal audio device according to the second aspect of the invention. The remarks set forth above in relation to the assembly are therefore equally applicable in relation to the personal audio device.

### BRIEF DESCRIPTION OF THE DRAWINGS

Embodiments of the invention will now be further described with reference to the drawings, in which:

FIG. 1 illustrate insertion of a transducer into a cavity of a housing portion,

FIGS. 2A and 2B illustrate an embodiment of an assembly,

FIGS. 3A and 3B illustrate an alternative embodiment of an assembly,

FIGS. 4A and 4B illustrate different views of an embodiment of an assembly,

FIGS. 5A and 5B illustrate different views of an embodiment of an assembly,

FIGS. 6A and 6B illustrate different views of an embodiment of an assembly,

FIGS. 7A, 7B, and 7C illustrate different views of an embodiment of an assembly,

FIGS. 8A and 8B illustrate different views of an embodiment of an assembly,

FIGS. 9A and 9B illustrate different views of an embodiment of an assembly,

FIGS. 10A and 10B illustrate different views of an embodiment of an assembly,

FIG. 11 illustrates an embodiment of an assembly,

FIG. 12 illustrates an embodiment of an assembly,

FIG. 13 illustrates an embodiment of an assembly,

FIG. 14 illustrates insertion of a transducer into a cavity,

FIGS. 15A and 15B illustrate different views of an embodiment of an assembly,

FIGS. 16A and 16B illustrate different views of an embodiment of an assembly,

FIG. 17 illustrates a housing portion with a cavity,

FIGS. 18A and 18B illustrate two different embodiments of an assembly,

FIG. 19 illustrates an embodiment of an assembly,

FIGS. 20A and 20B illustrate different embodiments of a transducer,

FIG. 21 illustrates set of two transducers,

FIGS. 22A and 22B illustrate different views of an embodiment of an assembly comprising two

transducers,

FIG. 23 illustrates two coupled transducers,

FIGS. 24A and 24B illustrate different embodiments of an assembly, and

FIG. 25 illustrates insertion of a transducer into a cavity.

### DETAILED DESCRIPTION OF THE DRAWINGS

It should be understood that the detailed description and specific examples, while indicating embodiments of the invention, are given by way of illustration only, since various changes and modifications within the spirit and scope of the invention will become apparent to those skilled in the art from this detailed description.

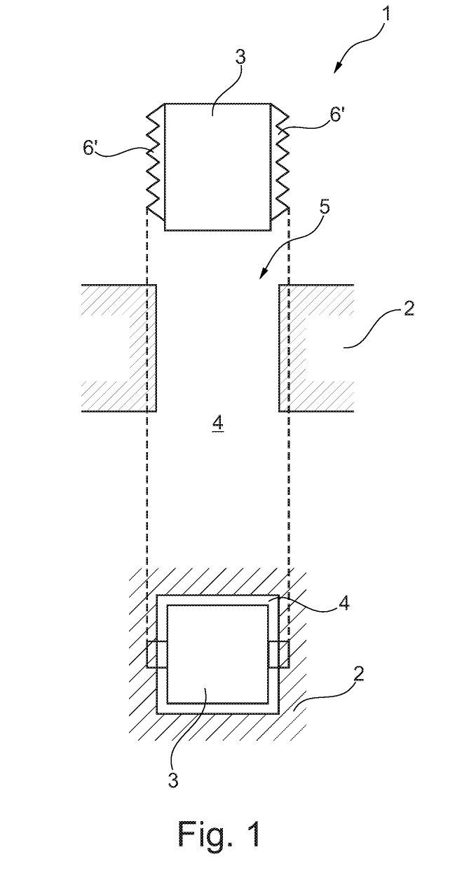

FIG. 1 schematically illustrates an assembly 1 for a personal audio device. The assembly 1 comprises a housing portion 2 and a transducer 3. The housing portion 2 comprises a cavity 4 configured to receive the transducer 3 via an opening 5 in the housing portion 2. The transducer 3 comprises a fixing member comprising an edge portion forming a serrated surface 6′ for engagement between the transducer 3 and an inner portion of the cavity 4.

In the upper part of FIG. 1, the assembly 1 is illustrated in a cross-sectional view with the transducer 3 not yet inserted into the cavity 4, whereas the lower part of FIG. 1 illustrates the assembly 1 from above where the transducer 3 is inserted into the cavity 4 of the housing portion 2.

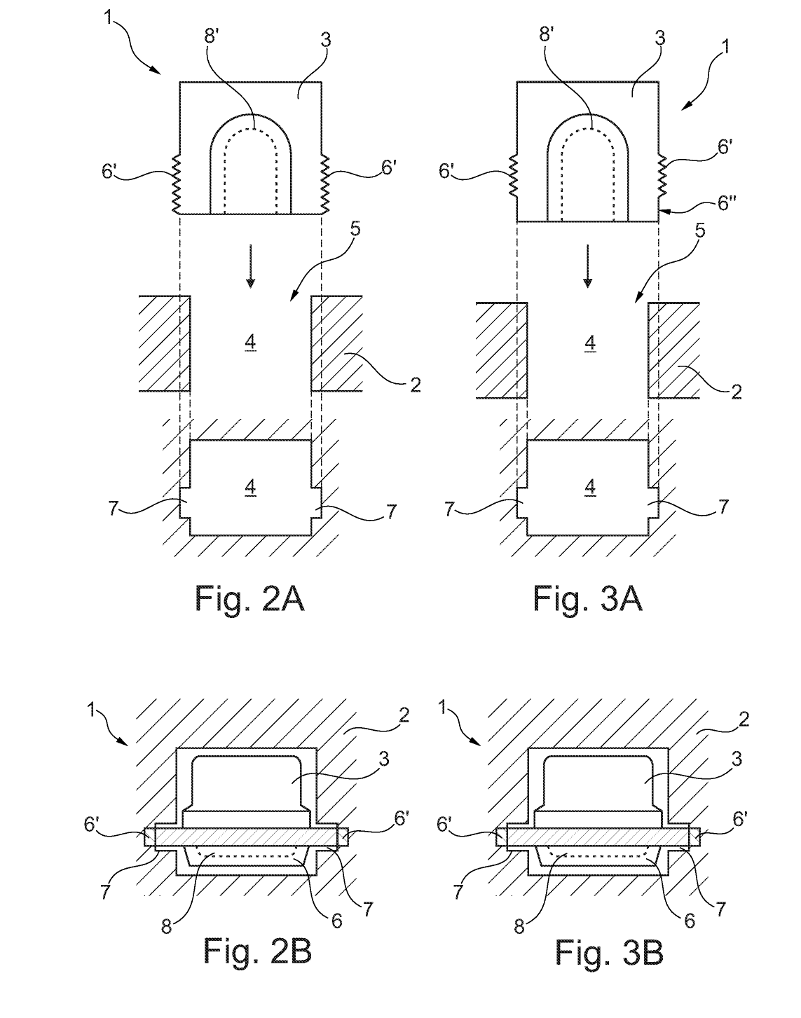

FIGS. 2A and 2B illustrate an alternative embodiment of an assembly 1. The assembly is similar to the embodiment illustrated in FIG. 1 with the difference that the serrated surface 6′ does not extend along the entire surface of the transducer 3.

The length of the serrated surface 6′ is less than the entire height of the transducer 3. The serrated surface 6′ in the embodiment illustrated in FIG. 2A, extends from the bottom of the transducer 3 along the transducer towards the middle of the transducer, whereas there is no serrated surface 6′ at the upper part of the transducer 3 in FIGS. 2A and 2B.

In the embodiment illustrated in FIGS. 2A and 2B, the fixing member 6 comprising an edge portion forming the serrated surface 6′ for engagement between the transducer 3 and an inner portion of the cavity 4 is formed as a separate element attached to the transducer 3.

In the illustrated embodiment, a part 7 of the cavity 4 has a shape which matches a part of the transducer 3 for engagement between the housing portion 2 and the transducer 3. As illustrated in the lower part of FIG. 2A, this part 7 is formed as an elongated indentation in the inner surface on opposite sides of the transducer 3. The indentations 7 extend from the opening and into the cavity 4 and are thereby configured to guide the transducer 3 during placement and removal of the transducer into and out of the cavity 4.

The transducer 3 forms a sound opening (not shown) for receiving sound or for outputting sound dependent on whether the transducer is an input device such as a microphone, or and output device such as a loudspeaker (receiver). The fixing member 6 is attached to the transducer 3 such that the sound opening is partly covered by the fixing member. Furthermore, the fixing member 6 is attached so that a gap 8 (see FIG. 2B) is provided between the fixing member 6 and the transducer 3. The gap 8 defines a spout member; i.e. a passage for sound from or to the transducer. In FIG. 2A, the spout member 8 is indicated with the dotted line 8′.

FIGS. 3A and 3B schematically illustrate an assembly 1 similar to the assemblies of FIGS. 2A and 2B. In FIG. 3B, the assembly 1 is seen from above thereby illustrating the gap 8 between the fixing member 6 and the transducer 3 forming the spout member.

The fixing member 6 comprises an edge portion 6″ extending from the transducer 3. The edge portion 6″ is configured to support the transducer 3 in the cavity 4. In the illustrated embodiment, the edge portion 6″ extending from the transducer 3 is an elongated element forming part of the fixing member 6. The edge portion 6″ is arranged at an outer surface of the transducer 3 substantially parallel to the insertion direction where by the transducer 3 can be inserted along the length of the edge portion 6″.

By omitting teeth at the lower end of the edge portion; i.e. the front end when inserting the transducer, the transducer and the housing portion may be aligned before the teeth of the serrated surface cut into the indentation 7. The un-serrated part of the edge portion 6″ may fit exactly into a part 7 of the cavity 4; i.e. into the elongated indentation 7 thereby facilitating accurate positioning of the transducer 3 relative to the housing portion 2.

The serrated surface 6′ forms part of the edge portion 6″ thereby extending in the elongated indentation 7 when the transducer 3 is inserted into the cavity 4.

The length of the serrated surface 6′ is less than the entire height of the transducer 3, as there is no serrated surface 6′ at the upper part of the transducer 3 in FIG. 3A; i.e. the serrated surface 6′ has endpoints which are not located at endpoint of the transducer 3.

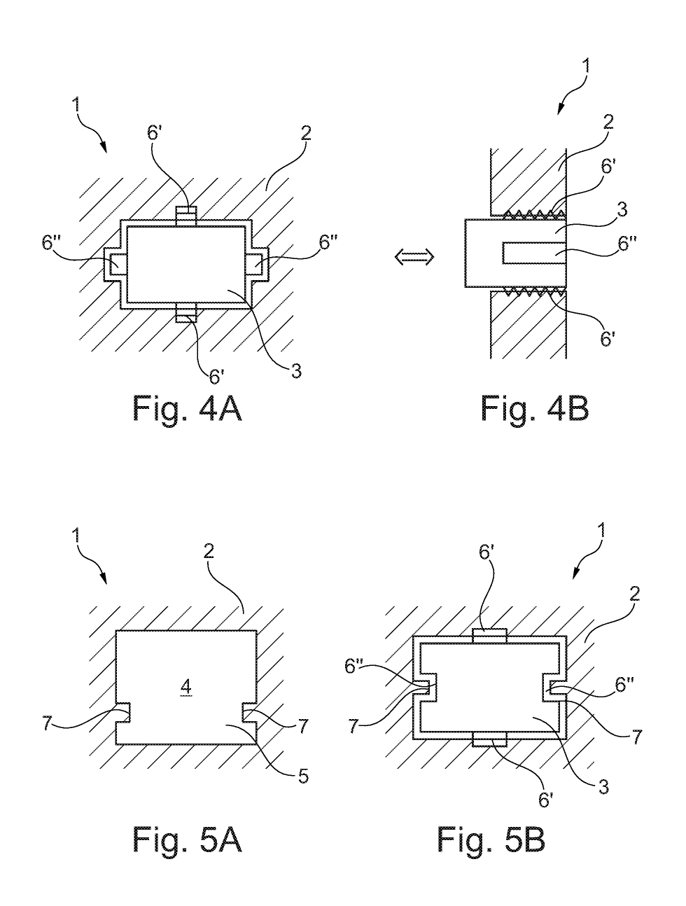

FIGS. 4A-7C illustrate different views and/or different embodiments of an assembly 1 for a personal audio device. The figures illustrate different details of the assemblies 1 comprising a housing portion 2 and a transducer 3. The housing portion 2 comprises a cavity 4 configured to receive the transducer 3 via an opening 5 in the housing portion 2. The transducer 3 comprises a fixing member 6 comprising an edge portion forming a serrated surface 6′ for engagement between the transducer 3 and an inner portion of the cavity 4.

FIGS. 4A and 4B illustrate different views of an embodiment of an assembly 1, where FIG. 4A is an upper view and FIG. 4B is a side view. In this embodiment, the edge portions 6″ and the serrated surfaces 6′ are arranged at different sides of the transducer 3, and thus extend transverse to each other.

FIG. 5A illustrates a housing portion 2 with a cavity 4 and an opening 5 into the cavity. A part 7 of the cavity 4 has a shape which matches a part of the transducer 3 for engagement between the housing portion 2 and the transducer 3. In the illustrated embodiment, the part 7 is a protrusion into the cavity 4 matching an indentation at the transducer (not shown).

FIG. 5B illustrates an assembly 1 where a transducer 3 is inserted into the cavity 4. A protruding part 7 of the cavity 4 has a shape which matches a part of the transducer 3 for engagement between the housing portion 2 and the transducer 3. The protruding part 7 matches the shape of the edge portion 6″ being an indentation in the transducer 3. The serrated surfaces 6′ are arranged transverse to the edge portions 6″.

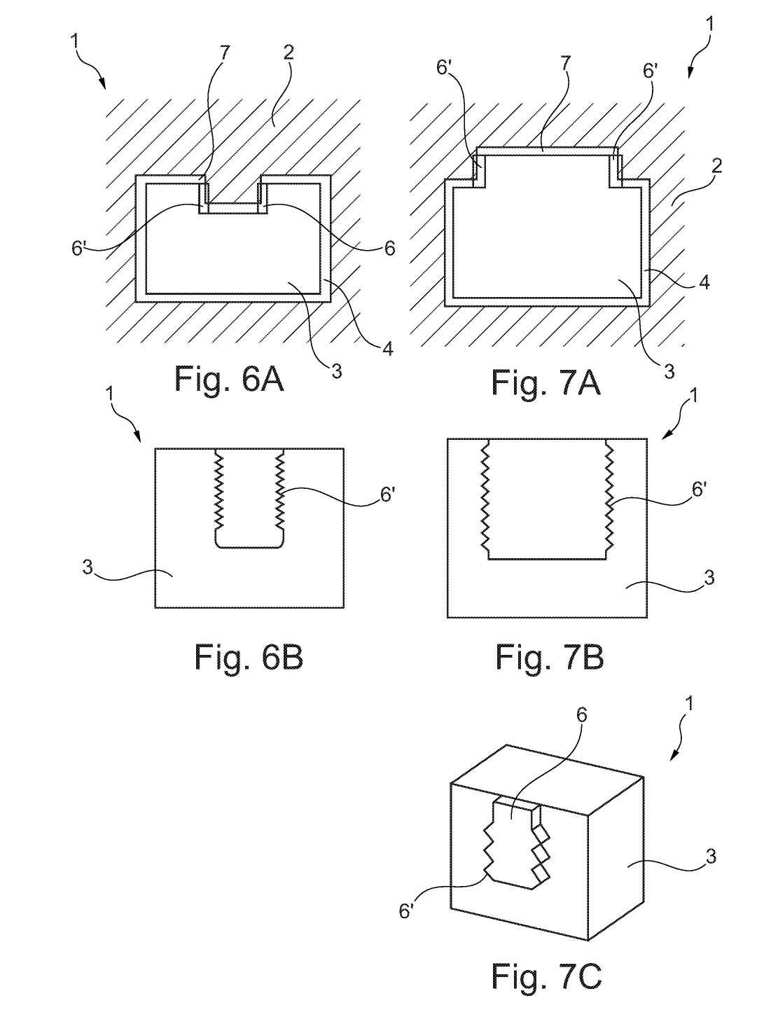

FIGS. 6A and 6B illustrate different views of an embodiment of an assembly 1, where FIG. 6A is an upper view and FIG. 6B is a side view. A protruding part 7 of the cavity 4 has a shape which matches a part of the transducer 3 for engagement between the housing portion 2 and the transducer 3. The protruding part 7 matches the shape of the edge portion 6″ being an indentation in the transducer 3. In this embodiment, the serrated surfaces 6′ forms part of the edge portion 6″.

FIGS. 7A, 7B, and 7C illustrate different views of an embodiment of an assembly 1, where FIG. 7A is an upper view, FIG. 7B is a side view, and FIG. 7C is a 3D illustration. An indentation part 7 of the cavity 4 has a shape which matches a part of the transducer 3 for engagement between the housing portion 2 and the transducer 3. The indentation part 7 matches the shape of the edge portion 6″ being a protrusion at the transducer 3. In this embodiment, the serrated surfaces 6′ forms part of the edge portion 6″.

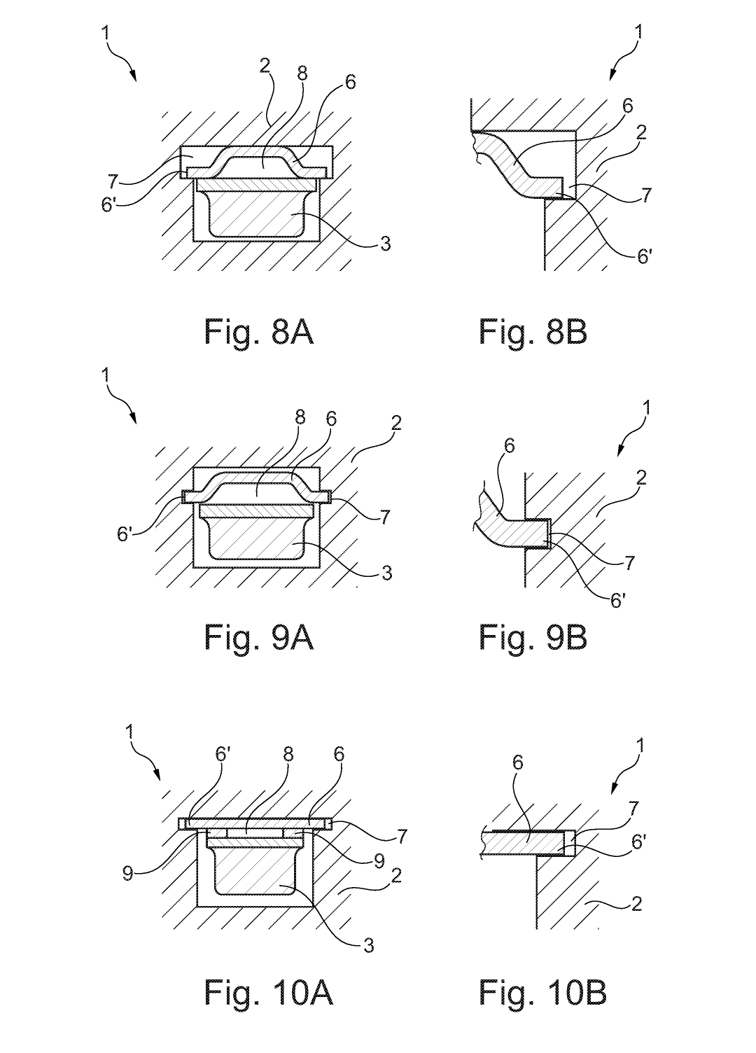

FIGS. 8A-12 schematically illustrate different views and/or different embodiments of an assembly 1. The figures illustrate different details of the assemblies 1 comprising a housing portion 2 and a transducer 3. The housing portion 2 comprises a cavity 4 configured to receive the transducer 3 via an opening 5 in the housing portion 2. The transducer 3 comprises a fixing member 6 comprising an edge portion forming a serrated surface 6′ for engagement between the transducer 3 and an inner portion of the cavity 4. The indentation part 7 matches the shape of the edge portion 6″ being a protrusion at the transducer 3. In these embodiments, the serrated surfaces 6′ forms part of the edge portion 6″. The fixing member 6 is attached so that a gap 8 is provided between the fixing member 6 and the transducer 3 to thereby define a spout member.

FIGS. 8A and 8B illustrate different views of an embodiment of an assembly 1, as described above. FIG. 8B is an enlarged view of a part FIG. 8A. In the illustrated embodiment, the size of the indentation part 7 is larger than the size of the edge portion 6″ being a protrusion at the transducer 3, which may facilitate manufacturing of the housing portion 2. However, to ensure fixing of the transducer 3, a tight fit is between provided between the fixing member 6 and the inner surface of the cavity, both at a middle portion of the fixing member 6 and at the edge portion 6″.

FIGS. 9A and 9B illustrate different views of an embodiment of an assembly 1, as described above. FIG. 9B is an enlarged view of a part FIG. 9A. In the illustrated embodiment, the size of the indentation part 7 is equal to the size of the edge portion 6″ being a protrusion at the transducer 3 to ensure a tight fit is between the fixing member 6 and the indentation part 7.

FIGS. 10A and 10B illustrate different views of an embodiment of an assembly 1, as described above. FIG. 10B is an enlarged view of a part FIG. 10A. In the illustrated embodiment, the fixing member 6 is a straight element attached so that a gap 8 is provided between the fixing member 6 and the transducer 3 to thereby define a spout member. This is achieved by use of two spacers 9. The size of the indentation part 7 is equal to the size of the edge portion 6″ being a protrusion at the transducer 3 to ensure a tight fit is between the fixing member 6 and the indentation part 7.

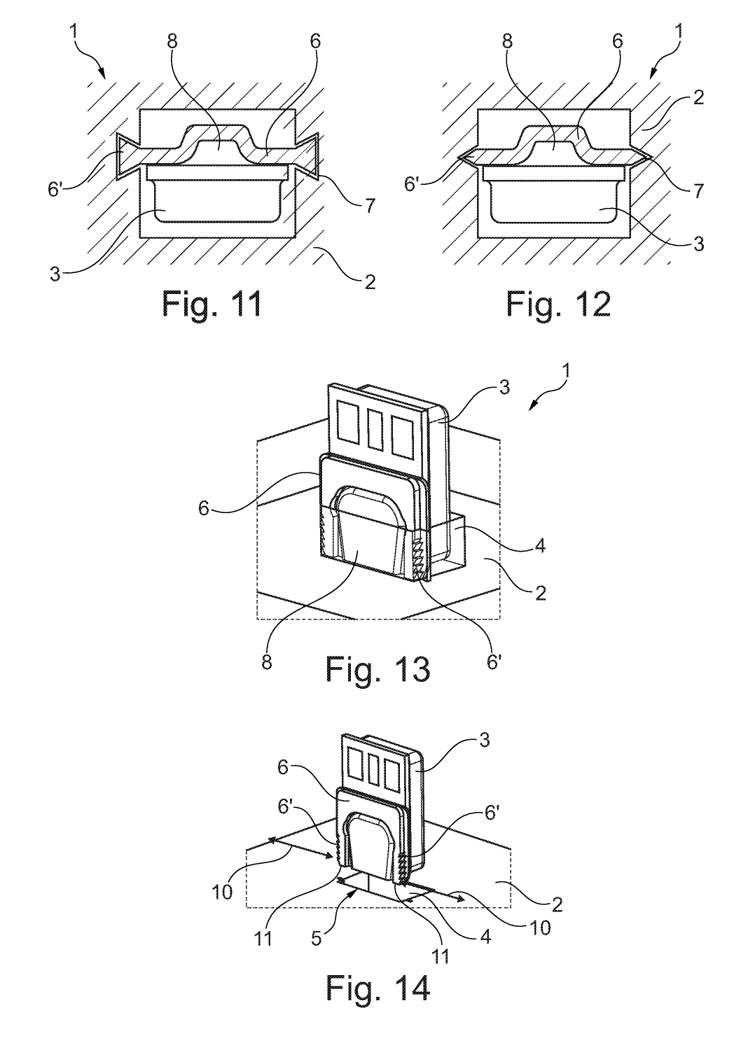

FIG. 11 illustrates an embodiment of an assembly 1, as described above. In the illustrated embodiment, the size of the indentation part 7 is equal to the size of the edge portion 6″ being a protrusion at the transducer 3 to ensure a tight fit is between the fixing member 6 and the indentation part 7. By use of matching shapes of the indentation part 7 and the edge portion 6″ guiding of the transducer 3 into the cavity 4 is facilitated.

FIG. 12 illustrates an embodiment of an assembly 1, as described above. The embodiment illustrated in FIG. 12 is similar to the embodiment in FIG. 11 with the exception of the shape of the edge portion 6″ which in this embodiment is formed as a triangle.

FIG. 13 illustrates an embodiment of an assembly 1 comprising a housing portion 2 and a transducer 3. The housing portion 2 comprises a cavity 4 configured to receive the transducer 3 via an opening 5 in the housing portion 2. The transducer 3 comprises a fixing member 6 comprising an edge portion forming a serrated surface 6′ for engagement between the transducer 3 and an inner portion of the cavity 4. In the illustrated embodiment, the fixing member 6 forms two oppositely facing serrated surfaces 6′. The fixing member 6 is attached so that a gap 8 is provided between the fixing member 6 and the transducer 3 to thereby define a spout member.

FIG. 14 illustrates insertion of the transducer 3 of FIG. 13 into the cavity 4. As illustrated by the arrows 10, the serrated surfaces 6′ are formed at the edge portion forming two movable legs 11 which may facilitate insertion of the transducer 3 into the housing portion 2.

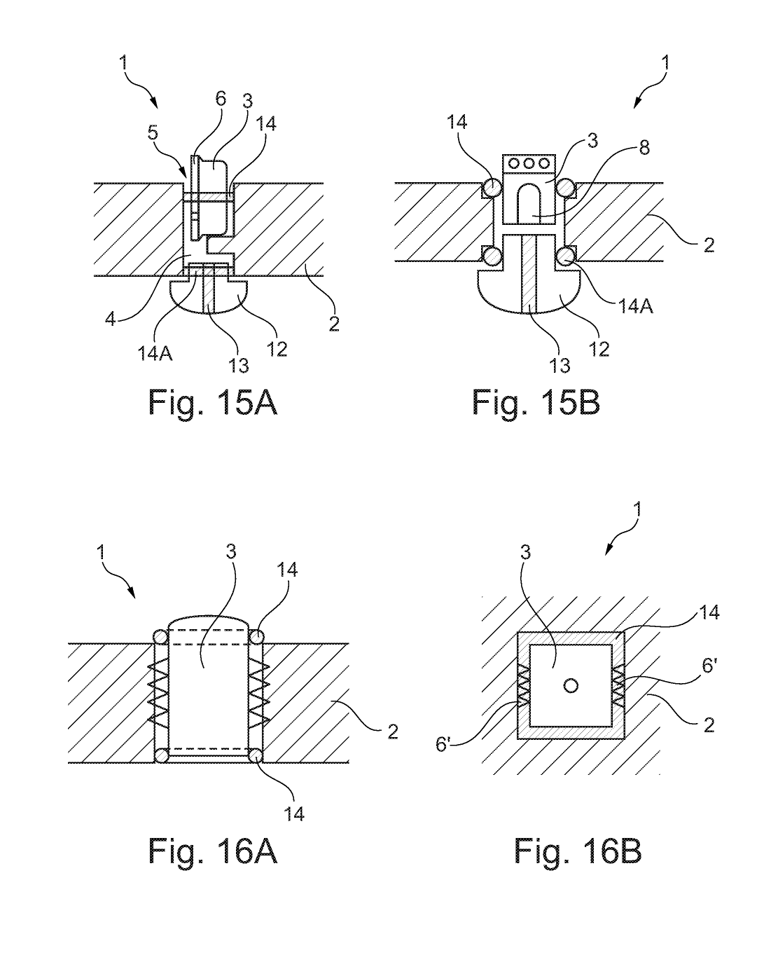

FIGS. 15A and 15B illustrate different views of an embodiment of an assembly 1. The assembly 1 comprises a housing portion 2 and a transducer 3. The housing portion 2 comprises a cavity 4 configured to receive the transducer 3 via an opening 5 in the housing portion 2. The transducer 3 comprises a fixing member 6 forming a serrated surface (not shown) for engagement between the transducer 3 and an inner portion of the cavity 4.

The illustrated assembly 1 additionally comprises a separate spout element 12 with a sound channel 13. Furthermore, the assembly 1 comprises a sealing member 14 arranged in the cavity to seal a gap between the transducer 3 and the housing portion 2. The sealing member 14 is formed of a flexible material thereby facilitating positioning of the sealing member 14 around the transducer 3. An additional sealing member 14A is arranged around the separate spout element 12.

FIGS. 16A and 16B illustrate different views of an embodiment of an assembly 1. The assembly 1 comprises a housing portion 2 and a transducer 3. The housing portion 2 comprises a cavity 4 configured to receive the transducer 3 via an opening 5 in the housing portion 2. The transducer 3 comprises a fixing member 6 forming a serrated surface 6′ for engagement between the transducer 3 and an inner portion of the cavity 4.

The illustrated assembly 1 additionally comprises two sealing members 14 made of epoxy and arranged around the transducer 3 in the cavity to seal a gap between the transducer 3 and the housing portion 2.

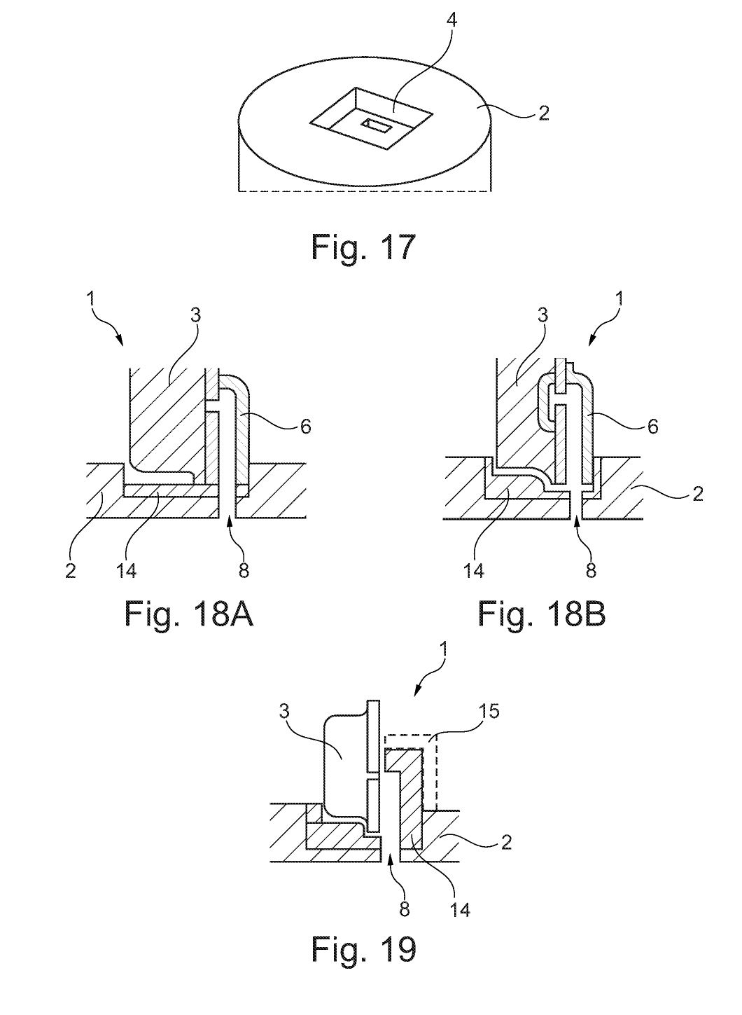

FIG. 17 illustrates a housing portion 2 with a cavity 4 into which a transducer (not shown) may be inserted.

FIGS. 18A and 18B illustrate two different embodiments of an assembly 1. The assemblies 1 comprise a housing portion 2 and a transducer 3. The housing portion 2 comprises a cavity 4 configured to receive the transducer 3 via an opening 5 in the housing portion 2. The transducer 3 comprises a fixing member 6 comprising an edge portion forming a serrated surface (not shown) for engagement between the transducer 3 and an inner portion of the cavity 4.

Each of the illustrated assemblies 1 additionally comprises a sealing member 14 made of epoxy and arranged in the cavity to seal a gap between the transducer 3 and the housing portion 2. It should be understood, that the sealing member 14 may be made of an adhesive, such as epoxy, silicone, or other adhesives. Alternatively, the sealing member 14 may be made of an soft material, such as silicone, silicone rubber, polyurethane, or similar materials.

FIG. 19 illustrates an embodiment of an assembly 1 similar to the embodiment illustrated in FIGS. 18A and 18B. However, the embodiment in FIG. 19 comprises an optional support member 15 for additional support of the transducer 3 in the cavity 4, and a sealing member 14.

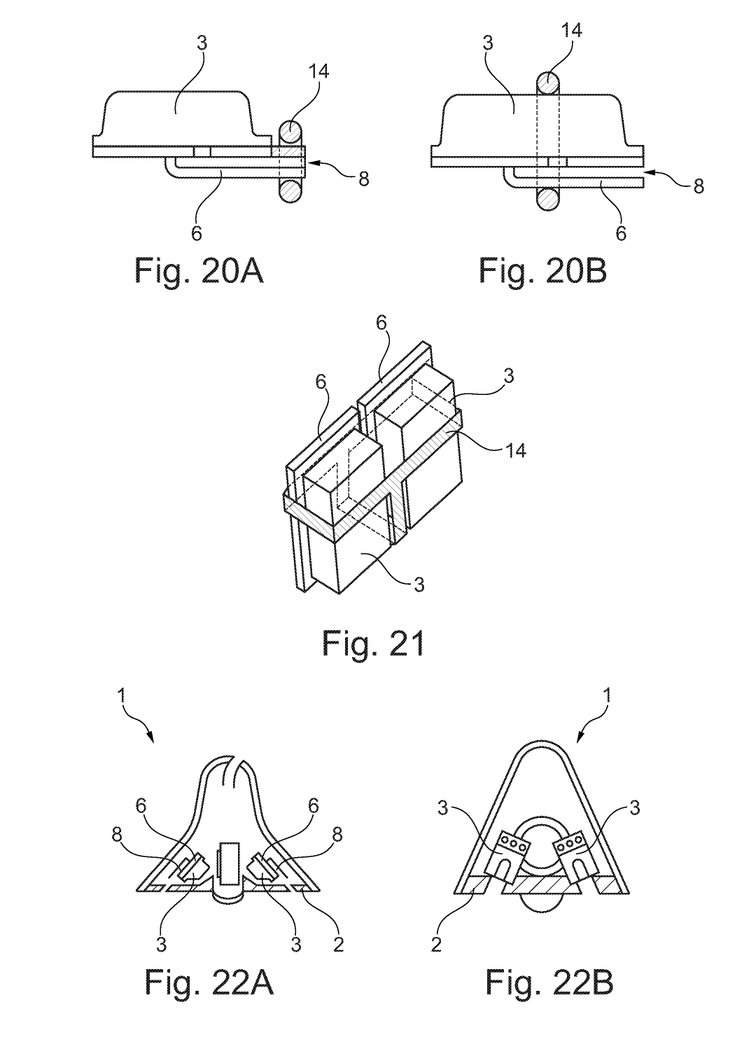

FIGS. 20A and 20B illustrate different embodiments of a transducer 3. The transducer 3 comprises a fixing member 6 attached to the transducer 3 so that a gap 8 is provided. The gap 8 defines a spout member. A sealing member 14 formed of a flexible material is arranged around the transducer 3. The sealing member 14 is arranged at different locations at the embodiments of FIGS. 20A and 20B.

FIG. 21 illustrates a set of two transducers 3 for an assembly (not illustrated). Each of the two transducers 3 comprises a fixing member 6. The transducers 3 are attached to each outer by a flexible material 14 which also acts as a sealing member when the set of transducers 3 are inserted into the cavity of a housing portion (not shown).

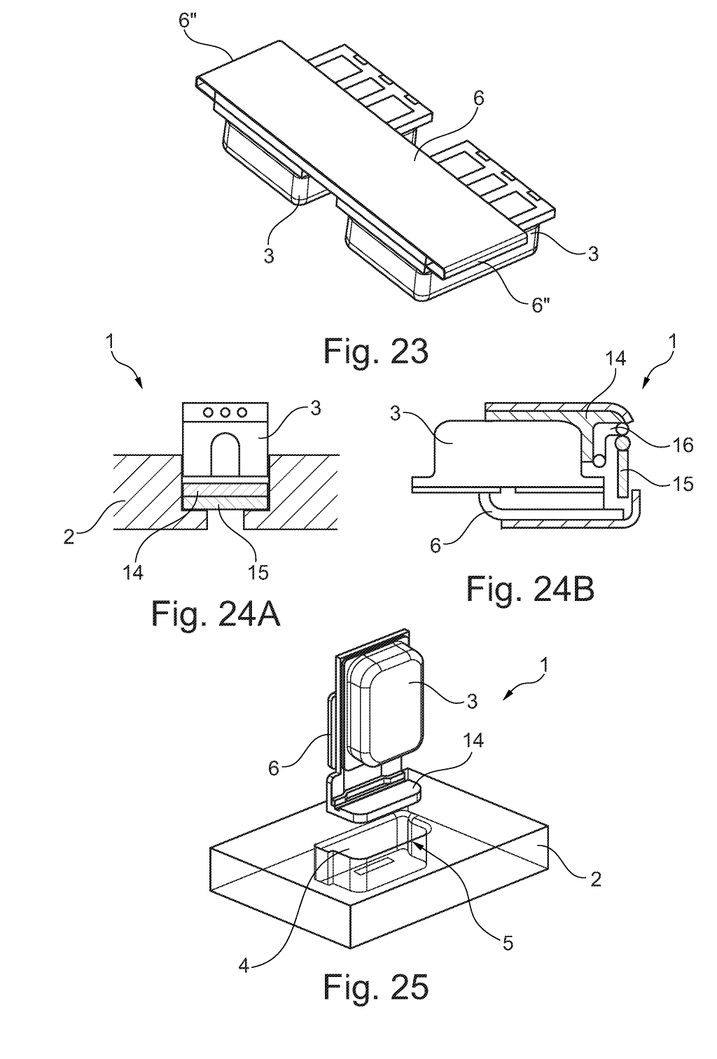

FIGS. 22A and 22B illustrate different views of an embodiment of an assembly 1 comprising two transducers 3. Each of the transducers 3 comprises a fixing member 6 attached to the transducer 3 so that a gap 8 is provided. The gap 8 defines a spout member. The transducers 3 are arranged at an angle relative to the housing portion 2. It should be understood, that in embodiments comprising a single transducer, this single transducer may also be arranged at an angle relative to the housing portion.

FIG. 23 illustrates two coupled transducers 3. The coupled transducers 3 comprise a common fixing member 6 comprising an edge portion 6″ arranged at opposite ends hereof. The serrated surface is not illustrated.

FIGS. 24A and 24B illustrate two different embodiments of an assembly 1. The assemblies 1 comprise a housing portion 2 and a transducer 3. The housing portion 2 comprises a cavity 4 configured to receive the transducer 3 via an opening 5 in the housing portion 2. The transducer 3 comprises a fixing member 6 comprising an edge portion forming a serrated surface (not shown) for engagement between the transducer 3 and an inner portion of the cavity 4.

Each of the illustrated assemblies 1 additionally comprises a sealing member 14 made of elastic material and arranged in the cavity to seal a gap between the transducer 3 and the housing portion 2.

Furthermore, each of the illustrated assemblies 1 comprises a filter element 15 arranged at the transducer 3 for contamination protection hereof and/or for conditioning of the sound spectrum. The filter element 15 may be a grid, a fabric, a porous material, or similar.

The filter 15 forms two parallel acoustic paths, i.e. an acoustically resistive element 15 (e.g. a grid) and an acoustically inductive element 16 (e.g. a tube). The sound coming through the the paths combine in a common volume in front of the sound opening of the transducer 3.

FIG. 25 illustrates insertion of a transducer 3 into a cavity 4 of a housing portion 2. The transducer 3 comprises a fixing member 6 comprising an edge portion forming a serrated surface (not shown) for engagement between the transducer 3 and an inner portion of the cavity 4.

Furthermore, the fixing member 6 comprises a sealing member 14 extending from the transducer 3. The sealing member 14 is configured to support the transducer 3 in the cavity 4. In the illustrated embodiment, the sealing member 14 extends downwardly from the transducer 3. The sealing member 14 has a shape matching the opening 5 of the cavity 4. If the sealing member 14 is attached to the transducer 3 prior to insertion of the transducer 3 into the cavity 4, the sealing member 14 may act both as a sealing member and as a guide facilitation positioning and insertion of the transducer. If the sealing member 14 is attached to the transducer 3 after insertion of the transducer into the cavity 4, the sealing member may only act as a sealing member.

1. An assembly for a personal audio device configured to amplify and process a signal and to output this signal as sound into an ear canal of a user, the assembly comprising a housing portion and a transducer, wherein the housing portion comprises a cavity configured to receive the transducer via an opening in the housing portion, and wherein the transducer comprises a fixing member configured for attachment of the transducer to the housing, wherein the fixing member comprises an edge portion extending from the transducer and being configured to support the transducer in the cavity, and the edge portion forms a serrated surface for engagement between the transducer and an inner portion of the cavity.

2. An assembly according to claim 1, wherein at least a part of the cavity has a shape matching at least a part of the transducer for engagement between the housing portion and the transducer by frictional forces.

3. An assembly according to claim 1, wherein the cavity comprises at least one elongated indentation formed in an inner surface, the indentation extending from the opening and into the cavity and being configured to guide the transducer during placement and removal of the transducer into and out of the cavity.

4. An assembly according to claim 3, wherein the edge portion is configured for insertion into the elongated indentation.

5. An assembly according to claim 3, wherein the elongated indentation extends transverse to the serrated surface.

6. An assembly according to claim 1, wherein the housing portion comprises an engagement portion for engagement with the serrated surface, the engagement portion comprising material being softer than serrated surface.

7. An assembly according to claim 1, further comprising a sealing member arranged in the cavity to seal a gap between the transducer and the housing portion.

8. An assembly according to claim 1, wherein the transducer forms a sound opening and wherein the fixing member is attached to the transducer such that the sound opening is partly covered by the fixing member and such that a gap between the fixing member and the transducer defines a spout member.

9. An assembly according to claim 1, further comprising an acoustic filter arranged at the transducer.

10. An assembly according to claim 1, further comprising a porous element arranged at the transducer for contamination protection of the transducer.

11. An assembly according to claim 1, further comprising a polymer foil arranged in the cavity for contamination protection of the transducer.

12. A personal audio device comprising an assembly according to claim 1.
